(19) United States
(12) Patent Application Publication
(10) Pub. No.: US 2023/0028654 A1
(43) Pub. Date: Jan. 26, 2023

(54) OPERATION LOG ACQUISITION DEVICE AND OPERATION LOG ACQUISITION METHOD

(71) Applicant: Nippon Telegraph and Telephone Corporation, Tokyo (JP)

(72) Inventors: Kimio Tsuchikawa, Musashino-shi, Tokyo (JP); Takeshi MASUDA, Musashino-shi, Tokyo (JP); Fumihiro YOKOSE, Musashino-shi, Tokyo (JP); Yuki Urabe, Musashino-shi, Tokyo (JP); Sayaka Yagi, Musashino-shi, Tokyo (JP)

(21) Appl. No.: 17/786,620

(22) PCT Filed: Jan. 8, 2020
(86) PCT No.: PCT/JP2020/000346

§ 371 Date: Jun. 17, 2022

(51) Int. Cl. G06V 10/762; G06V 10/764; G06V 10/74

(52) U.S. Cl. CPC G06V 10/762; G06V 10/764; G06V 10/761; G06V 2201/02

(57) ABSTRACT

An acquisition unit (15a) detects an operation event of a user to acquire an occurrence position of the operation event in an operation screen and a captured image of the operation screen. An extraction unit (15b) extracts images that are able to become candidates for a GUI part from the acquired captured image, identifies which image the operation event has occurred on from the occurrence position of the operation event, and records an occurrence clock time of the operation event and the identified image in an associated manner. A classification unit (15c) classifies a group of recorded images into clusters in accordance with similarities of the images. A determination unit (15d) adds up the number of times the operation event has occurred in the images for each classified cluster, and in a case in which the aggregated value is equal to or greater than a predetermined threshold value, determines an image included in the cluster as an image of the GUI part that is an operation target at the occurrence clock time of the operation event.

### TECHNICAL FIELD

The present disclosure relates to an operation log acquisition apparatus and an operation log acquisition method.

### BACKGROUND ART

In work analysis, a method of displaying an operation procedure in the form of a flowchart is effective. In a case in which work of providing services and merchandise to customers is considered, an operation procedure for a system to provide the same service or merchandise may be set for each of the services or each type of merchandise, and this may be shared by operators through a manual or the like.

Also, because beginners are taught the operation procedure through a workshop or instruction provided by skilled persons, the procedure for processing the same merchandise or service should be the same operation procedure. However, because a variety of irregular events that are not expected, such as a change in what a customer orders after the order, the merchandise being out of stock, or an operation error of an operator, generally occur in practice, it is not practical to define operation procedures in advance for all these irregular events, and even if it were possible to define these operation procedures, it would be difficult for operators to remember all the operation patterns and select an appropriate procedure.

Therefore, various operation procedures are typically needed in practice for each order even for the same merchandise or service. In order to ascertain work statuses for the purpose of improving work, it is important to comprehensively ascertain all operation patterns including such irregular events. This is because procedures have not been clarified for the irregular events, and it is thus necessary to examine how to proceed the procedures or to ask persons who are in charge of the works how to proceed the procedures, there is a high probability that errors occur in the operation procedures, and it often takes longer time than for an ordinary operation pattern.

In such circumstances, a method of displaying an operation procedure in the form of a flowchart is effective. For example, a mechanism of clarifying differences in operation procedures for each order by using, as an input, an operation log recording operation clock times of an operator, types of operation (hereinafter, referred to as an operation type), and information for identifying the order (hereinafter, referred to as an order ID) for each order, lining up operation procedures for each of orders, and performing overlapping of flow displays of the operation procedures has been proposed.

Also, as a mechanism for acquiring an operation log with a granularity desired by an analyzer, a technique targeted at an operation screen of a GUI application, for example, in which attribute values of GUI parts constituting the operation screen are acquired when an event occurs and parts that have changed between before and after the occurrence of the event are found is known. In this manner, it is possible to extract only an event that has caused a change in attribute values, that is, an operation event that is meaningful in terms of work and to identify the operation location at the same time.

However, actual work is typically carried on while using various applications such as e-mail, Web, a work system, Word, Excel, and a scheduler, and it is necessary to develop a mechanism for acquiring attribute values of GUI parts and identifying changed locations in accordance with execution environments of all these applications, which actually incurs a significantly high cost and is not practical. Even if a mechanism were to be developed for such a target application, revision would be needed in accordance with occurrence of specification changes in the target execution environment due to version upgrades. In recent years, a thin-client environment has become widespread in companies for the purpose of effective use of computer resources and security measures. This corresponds to an environment in which an application has not been installed on a terminal (hereinafter, referred to as a client terminal) that actually performs operations performed by a user, the application has been installed on another terminal (server) connected to the client terminal, an operation screen provided by the application is displayed as an image on the client terminal, and the user operates the application on the server side through the displayed image. In this case, because the operation screen is displayed as an image on the terminal on which the user actually performs operations, it is not possible to acquire attribute values of GUI parts as described above from the client terminal.

Also, a mechanism for acquiring an operation log using events such as a keyboard input and mouse clicking has been proposed. This may be adapted such that only events that satisfy conditions designated in advance for each of tasks are recorded in an operation log using events such as mouse clicking and pressing of an enter key on the keyboard as triggers. It is thus possible to extract only events necessary for the analyzer while omitting events that are not necessary for analysis using such a mechanism.

### CITATION LIST

### Patent Literature

Patent Literature 1: JP 2015-153210 A

### Non-Patent Literature

NPL 1: Ogasawara et al., “Development of Work Process Visualization/Analysis System Using Work Execution History”, NTT Gijutsu Journal, 2009.2, P40 to P43

### SUMMARY OF THE INVENTION

### Technical Problem

However; it is not easy to acquire an operation log of an application according to the related art. For example, actual work is typically carried on while using a variety of applications, and it is not possible to state that creating a mechanism for acquiring operation logs for a large number of applications is realistic. Also, the related art has a problem that it is necessary to designate conditions in advance, which is complicated.

In view of such problems, a method of acquiring a captured image of an operation screen at a time at which a user is operating a terminal, extracting images that may be candidates for a GUI part using features on the image, identifying GUI parts that may be able to be operated from the occurrence positions of an event, and by using the identified GUI parts as an input, reproducing an operation flow is also conceivable as a method for acquiring an operation log necessary to reproduce an operation flow in a versatile manner regardless of an execution environment of a GUI application. In this case, because GUI parts that cannot be operated are also present in addition to GUI parts that can be operated on the operation screen, there is a problem that GUI parts that cannot be operated need to be distinguished and images of only GUI parts that can be operated need to be extracted.

The present disclosure was made in view of the aforementioned circumstances, and an object thereof is to acquire an operation log of a GUI application in a versatile manner regardless of an execution environment of a target application.

### Means for Solving the Problem

In order to solve the aforementioned problems and achieve the object, an operation log acquisition apparatus according to the present disclosure includes: an acquisition unit configured to detect an operation event of a user to acquire an occurrence position of the operation event in an operation screen and a captured image of the operation screen; an extraction unit configured to extract images that are able to become candidates for a GUI part from the acquired captured image, identify which image the operation event has occurred on from the occurrence position of the operation event, and record an occurrence clock time of the operation event and the identified image in an associated manner; a classification unit configured to classify a group of recorded images into clusters in accordance with similarities of the images; and a determination unit configured to add up a number of times the operation event has occurred in the images for each of the classified clusters and in a case in which an aggregated value is equal to or greater than a predetermined threshold value, determine an image included in the cluster as an image of the GUI part that is an operation target at the occurrence clock time of the operation event.

### Effects of the Invention

According to the present disclosure, it is possible to acquire an operation log of a GUI application in a versatile manner regardless of an execution environment of a target application.

### BRIEF DESCRIPTION OF DRAWINGS

FIG. 1 is a schematic view illustrating, as an example, an overview configuration of an operation log acquisition apparatus according to the present embodiment.

FIG. 2 is a diagram for explaining processing performed by an extraction unit.

FIG. 3 is a diagram for explaining processing performed by the extraction unit.

FIG. 4 is a diagram for explaining processing performed by the extraction unit.

FIG. 5 is a flowchart illustrating an operation log acquisition processing procedure.

FIG. 6 is a diagram illustrating an example of a computer that executes an operation log acquisition program.

### DESCRIPTION OF EMBODIMENTS

Hereinafter, an embodiment of the present disclosure will be described in detail with reference to the drawings. The present disclosure is not limited to the embodiment. Further, in description of the drawings, the same parts are denoted by the same reference signs.

Configuration of Operation Log Acquisition Apparatus

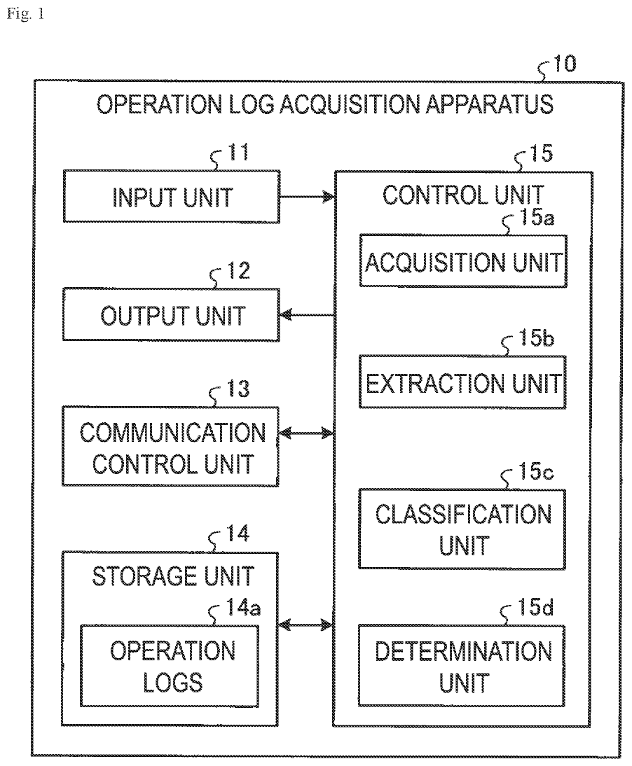

FIG. 1 is a schematic view illustrating, as an example, an overview configuration of an operation log acquisition apparatus according to the present embodiment. As illustrated in FIG. 1, an operation log acquisition apparatus 10 according to the present embodiment is realized by a general-purpose computer such as a PC or a work station and includes an input unit 11, an output unit 12, a communication control unit 13, a storage unit 14, and a control unit 15.

The input unit 11 is achieved by using an input device such as a keyboard or a mouse, and inputs various types of instruction information such as processing start to the control unit 15 in response to an input operation from an operator. The output unit 12 is realized by a display device such as a liquid crystal display, a printing device such as a printer, or the like. For example, a result of operation log acquisition processing, which will be described below, is displayed on the output unit 12.

The communication control unit 13 is realized by a network interface card (NIC) or the like and controls communication between the control unit 15 and an external apparatus via a telecommunication line such as a local area network (LAN) or the Internet. For example, the communication control unit 13 controls communication between the control unit 15 and a terminal or the like operated by a user. Note that the terminal may be mounted in the same hardware as the operation log acquisition apparatus 10.

The storage unit 14 is realized by a semiconductor memory element such as a random access memory (RAM) or a flash memory, or a storage device such as a hard disk or an optical disc. The storage unit 14 stores a processing program that causes the operation log acquisition apparatus 10 to operate, data used during execution of the processing program, and the like in advance or temporarily stores them every time processing is performed. Moreover, the storage unit 14 stores an operation log 14a that is a result of the operation log acquisition processing, which will be described below. The storage unit 14 may be configured to communicate with the control unit 15 via the communication control unit 13.

The control unit 15 is realized using a central processing unit (CPU) or the like and executes a processing program stored in a memory. In this manner, the control unit 15 functions as an acquisition unit 15a, an extraction unit 15b, a classification unit 15c, and a determination unit 15d as illustrated as an example in FIG. 1. Note that each or some of these functional units may be implemented in different hardware. Further, the control unit 15 may include other functional units.

The acquisition unit 15a detects an operation event of the user, such as mouse clicking or a keyboard input, to acquire an occurrence position of the operation event in an operation screen and a captured image of the operation screen. Specifically, in a case in which occurrence of an operation event is detected, the acquisition unit 15a acquires an occurrence clock time of the operation event, an occurrence position of the operation event, and a captured image of the operation screen. For example, the acquisition unit 15a has a function of detecting occurrence of an operation event such as a keyboard input or mouse clicking and a function of acquiring a captured image of the operation screen when the operation event is detected and notifying the determination unit 15d, which will be described below, of an operation event occurrence clock time, an operation event occurrence position, and the captured image of the operation screen.

The acquisition unit 15a can realize the detection of occurrence of an operation event using a global hook in a case of the Windows (trade name) OS. Similarly, the acquisition unit 15a can acquire the event occurrence position using a global hook in a case of mouse clicking, for example.

Moreover, the acquisition unit 15a can identify the occurrence position of the operation event by comparing captured images before and after occurrence of the operation event even in a case in which there is no means for acquiring an input position from the OS in a versatile manner for a keyboard input, for example. This is because a keyboard input is typically accompanied by an input of a character sequence. Note that although a change does not occur at a point and has a planar spread, any coordinates may be employed as long as the coordinates are included in the plane. In addition, although a keyboard input also includes operations that are not accompanied by an input, such as a tab key, a direction key, and a shift key, these do not have a meaning in analysis in man cases and will thus be ignored in the present embodiment.

Moreover, the acquisition unit 15a may acquire and record information regarding types of an operation event (mouse clicking or a keyboard input).

The extraction unit 15b extracts images that can be candidates for GUI parts from the acquired captured image. Then, the extraction unit 15b identifies, from an occurrence position of an operation event, which image the operation event has occurred on, and records an occurrence clock time of the operation event and the identified image in an associated manner. Specifically, the extraction unit 15b extracts, from the acquired captured image, images that can be candidates for GUI parts using features on the image, for example. For example, the extraction unit 15b identifies edges of the GUI parts using open source computer vision library (OpenCV) or the like and using color differences between a region occupied by each GUI part and the other regions as features. Then, the extraction unit 15b cuts out images that can be candidates for GUI parts from an operation image by cutting out circumscribing rectangles including edges with identified edges regarded as outlines.

At this time, the extraction unit 15b cuts out images including images in the surroundings of the images. In this manner, when the creation unit 15e, which will be described below, visualizes an operation flow using the images, operation locations on the operation screen are more easily recognized by the user. Also, images of GUI parts with similar images, such as text boxes, can be distinguished from each other.

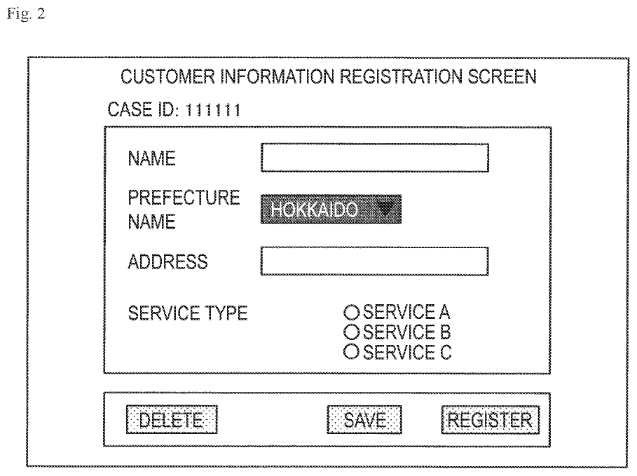

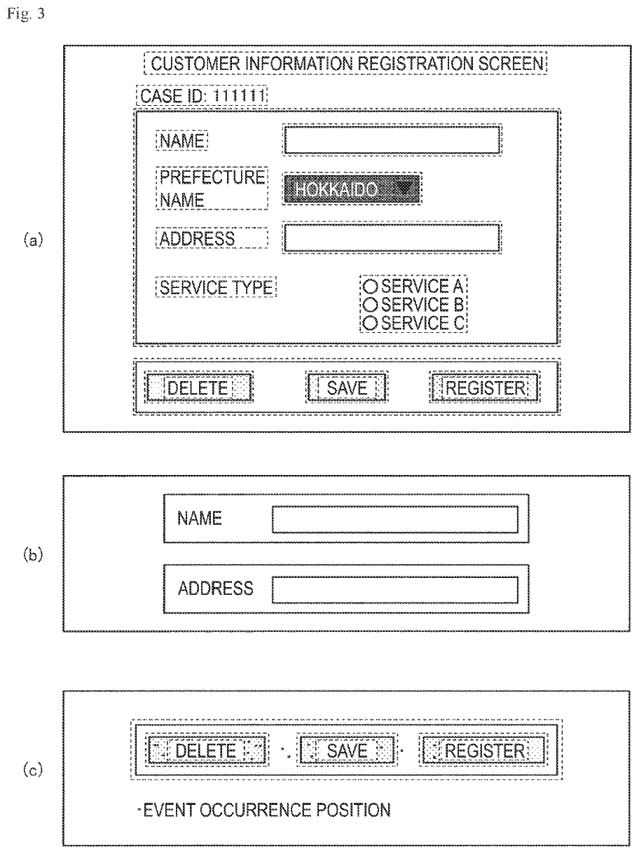

Here, FIGS. 2 to 4 are diagrams for explaining processing performed by the extraction unit 15b. FIGS. 3(a) to 3(c) illustrate, as an example, a case in which the extraction unit 15b cuts out images that are operation targets from the operation screen illustrated in FIG. 2. Specifically, FIG. 3(a) illustrates, as an example, images that are to be cut out as the images as illustrated by the surrounding dashed lines. Also, FIG. 3(b) illustrates, as an example, a case in which images of the text boxes that can be images of operation targets are extracted. As illustrated in FIG. 3(b), the extraction unit 15b can distinguish the different text boxes on the same operation screen by cutting out the images including images in the surroundings of the text boxes. In the example illustrated in FIG. 3(h), it is possible to distinguish a text box for inputting a name from a text box for inputting an address by cutting out images so as to include letter images in the surroundings of the identified text boxes, for example. Moreover, it is possible to achieve highly accurate classification by determining a similarity with a common region excluded.

Then, the extraction unit 15b identifies an image including an occurrence position of an operation event from the cut out images and stores the identified image, the occurrence position, and the occurrence clock time of the operation event in the storage unit 14 in an associated manner.

In a case in which cut out images have a nest relationship as illustrated in FIG. 3(c) at this time, the extraction unit 15b handles an event that has occurred in an inner image as an event that has been performed on the inner image and handles an event that has occurred between an outer image and an inner image as an event that has been performed on the outer image.

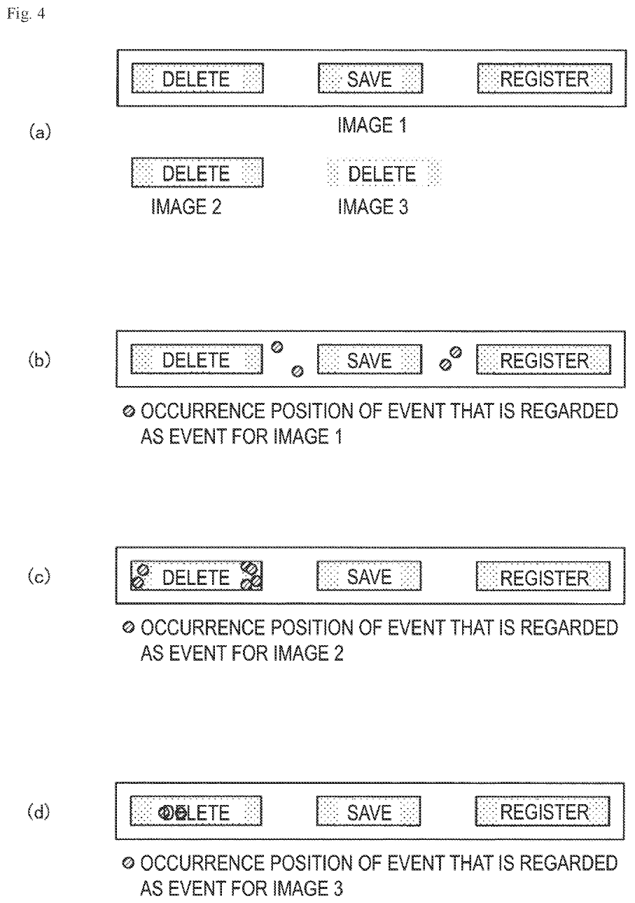

Also, FIG. 4(a) illustrates, as an example, images (images 1 to 3) cut out from FIG. 3(c). In addition, FIGS. 4(h) to 4(d) illustrate, as examples, occurrence positions of events that are to be regarded as events performed on each image. For example, FIG. 4(b) illustrates, as an example, an occurrence position of an event that is to be regarded as an event performed on the image 1.

Note that the extraction unit 15h may associate the identified image, the occurrence position, and the occurrence dock time of the operation event and transfer them to the classification unit 15c, which will be described below, without storing them in the storage unit 14.

FIG. 1 will be referred to again for explanation. The classification unit 15c classifies a group of recorded images into clusters in accordance with similarities among the images. For example, the classification unit 15c classifies the images in accordance with similarities of display positions of the images in the captured image of the operation screen. In this manner, the images representing a GUI part displayed at the same position on the operation screen are classified into the same cluster. In a case in which the operation screen has a fixed configuration, all the GUI parts are always displayed at the same positions, and it is thus possible to classify the images obtained 1w cutting out the same GUI parts into the same clusters.

Alternatively, the classification unit 15c classifies the images in accordance with similarities among the images in terms of the images. In this manner, the images obtained by cutting out the same GUI parts are classified into the same clusters. In a case in which the operation screen has a dynamically changing configuration, the display position of each GUI part changes, and it is thus not possible for the classification unit 15c to classify the images based on similarities of the display positions. To do so, the classification unit 15c classifies the images using similarities on the images. For determination of the similarities among the images, it is possible to perform similarity determination using pattern matching or various feature amounts and feature points, for example.

The determination unit 15d adds up the number of times an operation event has occurred in an image for each classified cluster, and in a case in which the aggregated value is equal to or greater than a predetermined threshold value, the determination unit 15d determines the image included in the cluster as an image of a GUI part that is an operation target of the occurrence clock time of the operation event. Specifically, the determination unit 15d adds up the number of times an operation event has occurred for each classified cluster, and in a case in which the aggregated value is equal to or greater than the predetermined value, the determination unit 15d determines the image included in the cluster as the image of the GUI part on which the operation has been performed at the occurrence clock time of the operation event. Then, the determination unit 15d associates and records the determined image with the occurrence clock time, generates an operation log 14a, and causes the storage unit 14 to store the generated operation log 14a. Also, the determination unit 15d may generate the operation log 14a with the type of the operation event further associated with the image.

Alternatively, the determination unit 15d may add up the number of times an operation event has occurred for each classified cluster, and in a case in which a proportion of the number of times of occurrence with respect to all operation events is equal to or greater than a predetermined threshold value, the determination unit 15d may determine the image included in the cluster as an image that is an operation target at the occurrence clock time of the operation event.

In this manner, operation events performed on GUI parts that cannot be operated are excluded. This is because user's operations can only be performed on GUI parts that can inherently be operated, and as a result, frequencies of events occurring in GUI parts that can be operated should have significant differences from frequencies of operation events occurring in GUI parts that cannot be operated.

Note that in a case in which cut images have a nest relationship and an image A on the outer side has been recorded as an operation log, the determination unit 15d excludes an image B on the inner side from candidates for an operation log. The reason for this is because a case in which the outer image corresponds to a GUI part that can be operated and a GUI part represented by the inner image can also be operated is significantly unnatural when a typical operation screen configuration is considered.

Also, in a case in which a plurality of inner images are present, there is a high probability that when one image is an image that is an operation target, the other inner images are also images that are operation targets, and the determination unit 15d can thus enhance accuracy of determination by adding all the nest relationship to determination conditions.

In order for an analyzer to distinguish images included in clusters for generating an operation log, the analyzer may add, for each cluster, any selected character sequences to the images included in the cluster and generate a flow using the character sequence. Moreover, it is also possible to extract characteristic character sequences from the images included in the clusters through OCR and to add the extracted character sequences as labels.

Operation Log Acquisition Processing

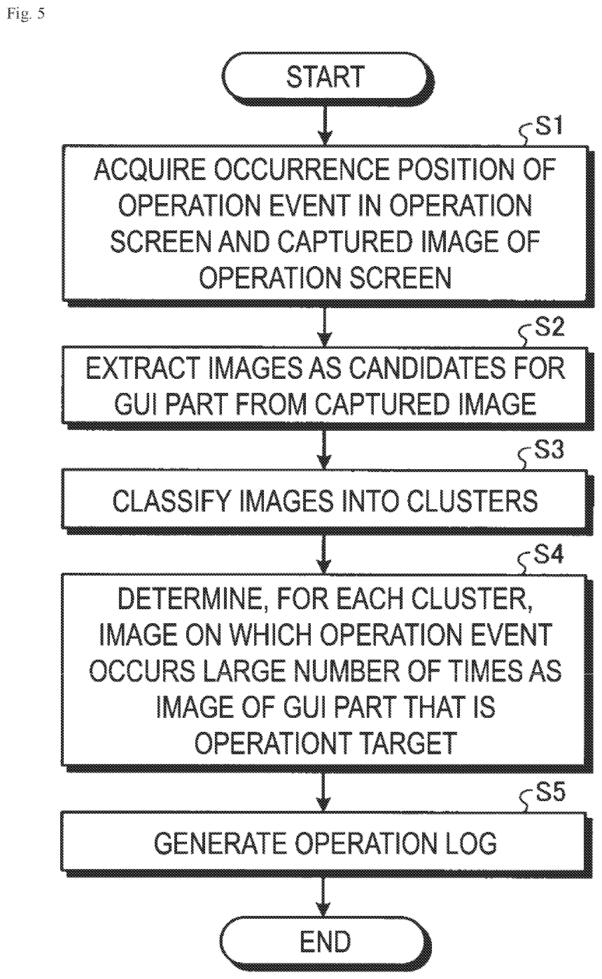

Next, operation log acquisition processing performed by the operation log acquisition apparatus 10 according to the present embodiment will be described with reference to FIG. 5. FIG. 5 is a flowchart illustrating the operation log acquisition processing procedure. The flowchart of FIG. 5 starts, for example, at a timing at which a user inputs an operation of giving a start instruction.

First, the acquisition unit 15a detects a user's operation event to acquire an occurrence position of the operation event in an operation screen and a captured image of the operation screen (Step S1).

Next, the extraction unit 15b extracts images that can be candidates for GUI parts from the acquired captured image (Step S2). Also, the extraction unit 15b identifies, from the occurrence position of the operation event, which image the operation event has occurred on and records the occurrence clock time of the operation event and the identified image in an associated manner. For example, the extraction unit 15b identifies, from the captured image, images that can be candidates for GUI parts using features on the image and cuts out the identified images from the captured image.

Next, the classification unit 15c classifies the extracted images into clusters in accordance with similarities among the images (Step S3). For example, the classification unit 15c classifies the images in accordance with similarities of display positions of the images in the captured image. Alternatively, the images are classified in accordance with similarities of the images in terms of the images.

The determination unit 15d adds up the number of times the operation event has occurred in the image for each classified cluster, and in a case in which the aggregated value is equal to or greater than a predetermined threshold value, the determination unit 15d determines the image included in the cluster as an image of a GUI part that is an operation target at the occurrence clock time of the operation event (Step S4). Also, the determination unit 15d associates and records the image with the occurrence clock time.

Alternatively, in a case in which a proportion of the number of times of occurrence of the operation event for each classified cluster with respect to all operation events is equal to or greater than a predetermined threshold value, the determination unit 15d determines the image included in the cluster as an image of a GUI part that is an operation target at the occurrence clock time of the operation event.

Also, the determination unit 15d generates the operation log 14a by correlating the image that has been determined as the image of the GUI part that is an operation target with the operation event occurrence clock time and the operation event type (Step S5). In addition, the determination unit 15d causes the storage unit 14 to store the generated operation log 14a. Alternatively, the determination unit 15d outputs the operation log 14a to an apparatus that creates an operation flow, for example. In this manner, a series of processes for the operation log acquisition processing ends.

As described above, the acquisition unit 15a detects the user's operation event to acquire the occurrence position of the operation event in the operation screen and the captured image of the operation screen in the operation log acquisition apparatus 10 according to the present embodiment. In addition, the extraction unit 15b extracts the images that can be candidates for GUI parts from the acquired captured image, identifies, from the occurrence position of the operation event, which image the operation event has occurred on, and records the occurrence clock time of the operation event and the identified image in an associated manner. Also, the classification unit 15c classifies a group of the recorded images into clusters in accordance with similarities among the images. Moreover, the determination unit 15d adds up the number of times the operation event that has occurred in the image for each classified cluster, and in a case in which the aggregated value is equal to or greater than the predetermined threshold value, the determination unit 15d determines the image included in the cluster as an image of the GUI part that is an operation target at the occurrence clock time of the operation event.

In this manner, the operation log acquisition apparatus 10 can easily and automatically acquire an operation log of an application without preparing teacher data or designating any conditions in advance regardless of the type of the GUI application. Further, the operation log acquisition apparatus 10 can extract only operation events performed on the GUI parts that can be operated.

In addition, the classification unit 15c classifies the images in accordance with similarities of display positions of the images in the captured image. In this manner, the operation log acquisition apparatus 10 can classify images obtained by cutting out the same GUI part into the same cluster in a case in which the configuration of the operation screen does not dynamically change.

Also, the classification unit 15c classifies the images in accordance with similarities of the images in terms of the images. In this manner, the operation log acquisition apparatus 10 can classify the images obtained by cutting the same GUI part into the same cluster in a case in which the configuration of the operation screen dynamically changes.

Additionally, in the case in which the proportion of the aggregated number of times of occurrence with respect to all the operation events is equal to or greater than the predetermined threshold value, the determination unit 15d determines the image included in the cluster as the image of the GUI part that is an operation target at the occurrence clock time. In this manner, the operation log acquisition apparatus 10 can extract only operation events performed on the GUI parts that can be operated.

Program

A program that describes the processing executed by the operation log acquisition apparatus 10 according to the aforementioned embodiment in a computer executable language can also be produced. As an embodiment, the operation log acquisition apparatus 10 can be implemented by causing a desired computer to install an operation log acquisition program, which executes the aforementioned operation log acquisition processing, as package software or on-line software. For example, it is possible to cause an information processing apparatus to function as the operation log acquisition apparatus 10 by causing the information processing apparatus to execute the aforementioned operation log acquisition program. The information processing apparatus described herein includes a desktop type or notebook type personal computer. In addition, the category of the information processing device includes a mobile communication terminal such as a smartphone, a cellular phone, and a personal handyphone system (PHS), a slate terminal such as a personal digital assistant (PDA), and the like. Also, the functions of the operation log acquisition apparatus 10 may be implemented on a cloud server.

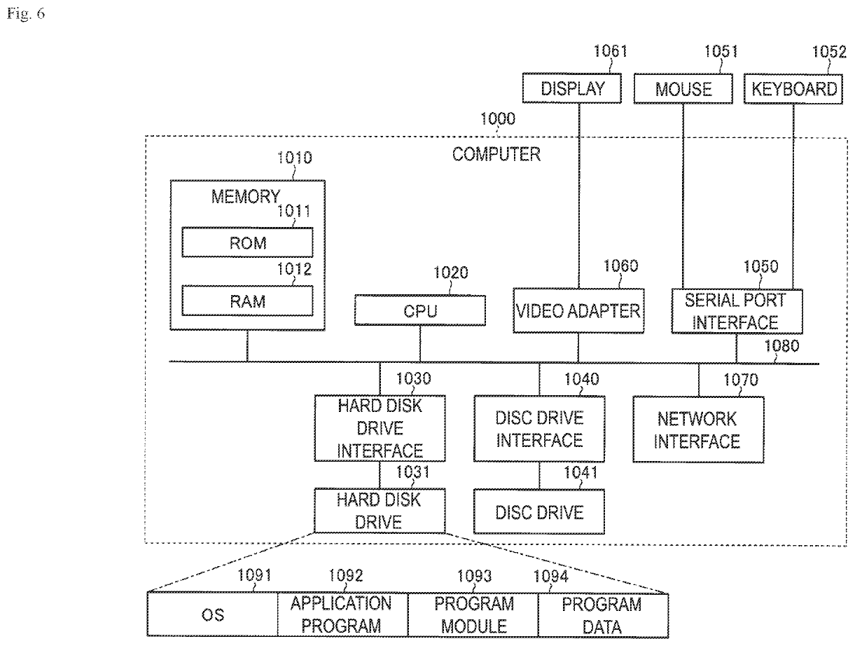

FIG. 6 is a diagram illustrating an example of a computer that executes the operation log acquisition program. A computer 1000 includes, for example, a memory 1010, a. CPU 1020, a hard disk drive interface 1030, a disc drive interface 1040, a serial port interface 1050, a video adapter 1060, and a network interface 1070. These units are connected by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disc drive interface 1040 is connected to the disc drive 1041. A removable storage medium such as a magnetic disk or an optical disc is inserted into the disc drive 1041. A mouse 1051 and a keyboard 1052, for example, are connected to the serial port interface 1050, A display 1061, for example, is connected to the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

Moreover, the operation log acquisition program is stored as the program module 1093 describing commands to be executed by the computer 1000, for example, in the hard disk drive 1031. Specifically, the program module 1093 describing processing to be executed by the operation log acquisition apparatus 10 described in the aforementioned embodiment is stored in the hard disk drive 1031.

Also, data used for information processing achieved by the operation log acquisition program is stored as the program data 1094 in the hard disk drive 1031, for example. The CPU 1020 reads the program module 1093 or the program data 1094 stored in the hard disk drive 1031 into the RAM 1012 as necessary to execute each of the above-described procedures.

Note that the program module 1093 and the program data 1094 according to the operation log acquisition program are not limited to the case in which they are stored in the hard disk drive 1031 and may be stored in a detachable storage medium, for example, and read by the CPU 1020 via the disc drive 1041 or the like. Alternatively, the program module 1093 and the program data 1094 according to the operation log acquisition program may be stored in another computer connected via a network such as a LAN or a wide area network (WAN) and may be read by the CPU 1020 via the network interface 1070.

Although the embodiment to which the disclosure made by the present inventor is applied has been described above, the present disclosure is not limited by the description and the drawings which constitute a part of the disclosure of the present disclosure according to the present embodiment. That is, other embodiments, examples, operation technologies, and the like made by those skilled in the art based on the present embodiment are all included in the scope of the present disclosure.

### REFERENCE SIGNS LIST

10 Operation log acquisition apparatus
11 Input unit
12 Output unit
13 Communication control unit
14 Storage unit
14a Operation log
15 Control unit
15a Acquisition unit
15b Extraction unit
15c Classification unit
15d Determination unit

1. An operation log acquisition apparatus comprising:
an acquisition unit, including one or more processors, configured to detect an operation event of a user to acquire an occurrence position of the operation event in an operation screen and a captured image of the operation screen;
an extraction unit, including one or more processors, configured to extract images that are able to become candidates for a GUI part from the acquired captured image, identify which image the operation event has occurred on from the occurrence position of the operation event, and record an occurrence clock time of the operation event and the identified image in an associated manner;
a classification unit, including one or more processors, configured to classify a group of recorded images into clusters in accordance with similarities of the images; and
a determination unit, including one or more processors, configured to add up a number of times the operation event has occurred in the images for each of the classified clusters, and in a case in which an aggregated value is equal to or greater than a predetermined threshold value, determine an image included in the cluster as an image of the GUI part that is an operation target at the occurrence clock time of the operation event.

2. The operation log acquisition apparatus according to claim 1, wherein the classification unit is configured to classify the images in accordance with at least either similarities of the images or similarities of display positions of the images in the captured image.

3. The operation log acquisition apparatus according to claim 1, wherein the determination unit is configured to determine that the image included in the cluster is the image of the GUI part
as the operation target at the occurrence clock time in a case in which a proportion of the number of times of occurrence with respect to all operation events is equal to or greater than a predetermined threshold value.

4. An operation log acquisition method that is executed by an operation log acquisition apparatus, the method comprising:
detecting an operation event of a user to acquire an occurrence position of the operation event in an operation screen and a captured image of the operation screen;
extracting images that are able to become candidates for a GUI part from the acquired captured image, identifying which image the operation event has occurred on from the occurrence position of the operation event, and recording an occurrence clock time of the operation event and the identified image in an associated manner;
classifying a group of recorded images into clusters in accordance with similarities of the images; and
adding up a number of times the operation event has occurred in the images for each classified cluster and in a case in which an aggregated value is equal to or greater than a predetermined threshold value, determining an image included in the cluster as an image of the GUI part that is an operation target at the occurrence clock time of the operation event.

5. The operation log acquisition method according to claim 4, further comprising:
classifying the images in accordance with at least either similarities of the images or similarities of display positions of the images in the captured image.

6. The operation log acquisition method according to claim 4, further comprising:
determining that the image including in the cluster is the image of the GUI part as the operation target at the occurrence clock time in a case in which a proportion of the number of times of occurrence with respect to all operation events is equal to or greater than a predetermined threshold value.

7. A non-transitory computer readable medium storing one or more instructions causing a computer to execute:
detecting an operation event of a user to acquire an occurrence position of the operation event in an operation screen and a captured image of the operation screen;
extracting images that are able to become candidates for a GUI part from the acquired captured image, identifying which image the operation event has occurred on from the occurrence position of the operation event, and recording an occurrence clock time of the operation event and the identified image in an associated manner;
classifying a group of recorded images into clusters in accordance with similarities of the images; and
adding up a number of times the operation event has occurred in the images for each classified cluster and in a case in which an aggregated value is equal to or greater than a predetermined threshold value, determining an image included in the cluster as an image of the GUI part that is an operation target at the occurrence clock time of the operation event.

8. The non-transitory computer readable medium according to claim 7, further comprising:
classifying the images in accordance with at least either similarities of the images or similarities of display positions of the images in the captured image.

9. The non-transitory computer readable medium according to claim 7, further comprising:
determining that the image including in the cluster is the image of the GUI part as the operation target at the occurrence clock time in a case in which a proportion of the number of times of occurrence with respect to all operation events is equal to or greater than a predetermined threshold value.
